(19) United States
(12) Patent Application Publication
(10) Pub. No.: US 2014/0379549 A1
(43) Pub. Date: Dec. 25, 2014

(54) System and Method for Aggregating Fixed Income Securities Data

(71) Applicant: TradingScreen Inc., New York, NY (US)

(72) Inventors: Philippe Buhannic, New York, NY (US); Jean Philippe Male, Paris (FR)

(21) Appl. No.: 14/309,126

(22) Filed: Jun. 19, 2014

Related U.S. Application Data
(60) Provisional application No. 61/837,374, filed on Jun. 20, 2013.

(51) Int. Cl. G06Q 40/04

(52) U.S. Cl. CPC G06Q 40/04
USPC 705/37

(57) ABSTRACT

Aggregating fixed income securities data from multiple market venues. Sets of data describing one or more fixed income securities are received from each of multiple market venues by a computer processor. Data contained within each of the sets of data is filtered to identify key/value data common to each set of data, the key/value data comprising, for each of the fixed income securities, securities industry identifier codes; a bid price; an ask price; a bid size; an ask size; a bid yield; an ask yield; a last trade price and quantity for executed trades; an execution time stamp; and a reference price. The filtered data is stored in a data repository.

### CROSS REFERENCE TO RELATED APPLICATIONS

This application claims the benefit of U.S. Provisional Patent Application No. 61/837,374, which is hereby incorporated by reference in its entirety.

### FIELD OF THE INVENTION

The subject matter described herein generally relates to aggregating fixed income security data.

### SUMMARY OF THE PREFERRED EMBODIMENTS

The present invention is directed to a computer implemented method, system and computer readable medium storing instructions which, when executed by a computer processor, cause the computer processor to perform the recited method. Sets of data describing one or more fixed income securities are received from each of multiple market venues by a computer processor. Data contained within each of the multiple sets of data is filtered to identify key/value data common to each set of data, the key/value data comprising, for each of the fixed income securities, securities industry identifier codes; a bid price; an ask price; a bid size; an ask size; a bid yield; an ask yield; a last trade price and quantity for executed trades; an execution time stamp; and a reference price. The filtered data is stored in a data repository. In some embodiments, the filtered data is displayed on a user interface. In certain other embodiments, a comparative analysis is performed on the filtered data and a result of the comparative analysis is displayed on the user interface. In still other embodiments, an analytical analysis is performed on the filtered data and a result of the analytical analysis is displayed on the user interface.

### BRIEF DESCRIPTION OF THE DRAWINGS

The foregoing summary, as well as the following detailed description of embodiments of the system and method, will be better understood when read in conjunction with the appended drawings of an exemplary embodiment. It should be understood, however, that the invention is not limited to the precise arrangements and instrumentalities shown.

In the drawings:

FIG. 1 is a diagram illustrating an exemplary system, including interaction among components of the system, that may be employed in connection with carrying out the methods of the present invention;

FIGS. 2A-2F are exemplary user interfaces that may be employed in connection with an embodiment of the present invention;

FIG. 3 is an exemplary user interface that may be employed in connection with an embodiment of the present invention; and

FIG. 4 is a flow diagram illustrating an exemplary method of the present invention.

### DETAILED DESCRIPTION

Fixed income securities are traded in many different market venues (e.g., including NYSE BondMatch, and multi-lateral trading facilities such as Galaxy). Although the development of electronic systems to trade fixed income securities has increased the transparency of the market, the separation of the market venues in which fixed income securities are traded presents challenges in efficiently determining the liquidity for particular securities available on each market venue.

The systems and methods described herein allow investors to obtain a consolidated view of the liquidity and availability of fixed income securities offered for purchase or sale across all markets. Further, display screens are provided that include the tools necessary to evaluate this supply. Still further, when interfaced with a trading execution system, the user can act on the information provided by way of the system, e.g., through the display screens, by efficiently executing a trading decision.

Thus, the systems and methods of the present invention involve consolidating order books of the various fixed income securities markets by combining the pricing and trade data from multiple market venues. Users are provided with an aggregated view of what fixed income securities market participants are willing to buy (“Bid”) or sell (“Ask”) at any point in time, as well as the size of offers made by market participants. The systems and methods may also involve enriching the information received from each of the market venues by adding in both analytical and calculated data (e.g., Bid/Ask yield, DV01, cumulative Bid/Ask size, Average Bid/Ask price, Bid/Ask spread against the reference Benchmark securities) that may be published on the various display screens, as described in more detail herein.

The systems and methods can be used by asset managers, private banks, alternative investment managers, investment banks and other broker-dealers as part of their investment and trading process for fixed income securities. The functionality afforded by the systems can be integrated with the trading workflow of the Execution Management Systems (“EMS”) or Order Management Systems (“OMS”) of such entities.

An exemplary process for aggregating fixed income securities trade data in accordance with the present invention is now described.

When the view panes (described below) are enabled on a user's screen, a consolidated listing of all securities available from all market venues in which such securities are traded is visible. Bid/Ask and trade information for the instruments available by way of that market venue can then be provided to the user.

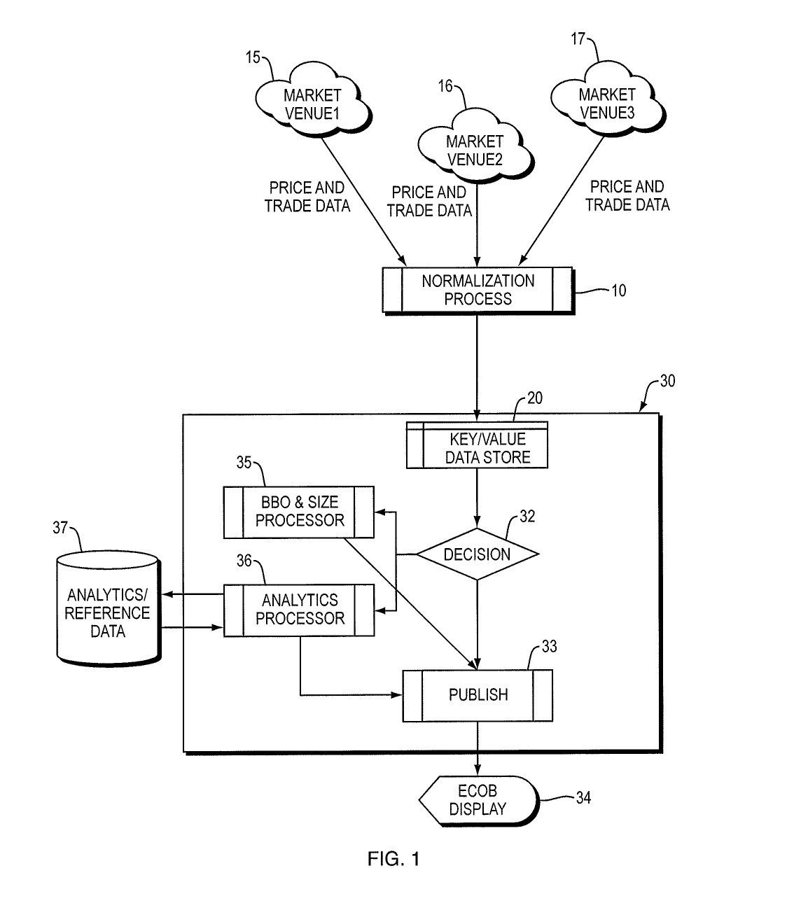

With reference to FIG. 1, computer application 10 (i.e., software executed on a computer processor) sends data requests to and receives in response data published from the computer systems of multiple market venues (e.g., market venue 15, 16 and 17). A user is thereby provided with up-to-date pricing and trade data across the various market venues.

Each market venue 15, 16, and 17 may utilize a different format for the data regarding a particular fixed income security it publishes. Computer application 10 accepts the information from each market venue in the format utilized by the market venue (e.g., FIX/FAST, FIX 4.4, NYSE UTP). Further, different market venues 15, 16, and 17 may provide different data elements. For example, some may provide quotes and trades, while others include securities descriptions or industry identifier codes. Computer application 10 performs a data normalization routine that filters the received data and accepts specific base data (e.g., key/value data) common to all market venues. This data is used to create the aggregated view and perform selected comparative and analytical calculations, described below.

In accordance with the data normalization process, computer application 10 identifies and tags key/value data elements contained within the information it receives from each market venue 15, 16, and 17. The key/value data elements include the securities industry identifier code (e.g., International Securities Identification Numbers, or ISINs, Bloomberg codes, Reuters codes) for the securities currently actively traded on each market venue; the Bid/Ask Price for each security; the Bid/Ask Size for each security; the Bid/Ask Yield for each security; the Last Trade Price and Quantity for executed trades; the Execution time stamp information; and the Reference Price for each security. This key/value information is then stored by computer application 10 in a data repository 20.

Throughout the trading day, the computer application 10 continues to receive price and trade data from each market venue 15, 16 and 17, which data is then subjected to the normalization process to evaluate if subsequent messages received from each market venue contain any new price or trade information for each security. If any new key/value element is received from a market venue, it is then stored by the computer application 10 in data repository 20.

The computer application 30 (i.e., software executed on a computer processor) executes decisions and performs comparative and analytical calculations on certain of the stored key/value data elements received from the various market venues 15, 16 and 17.

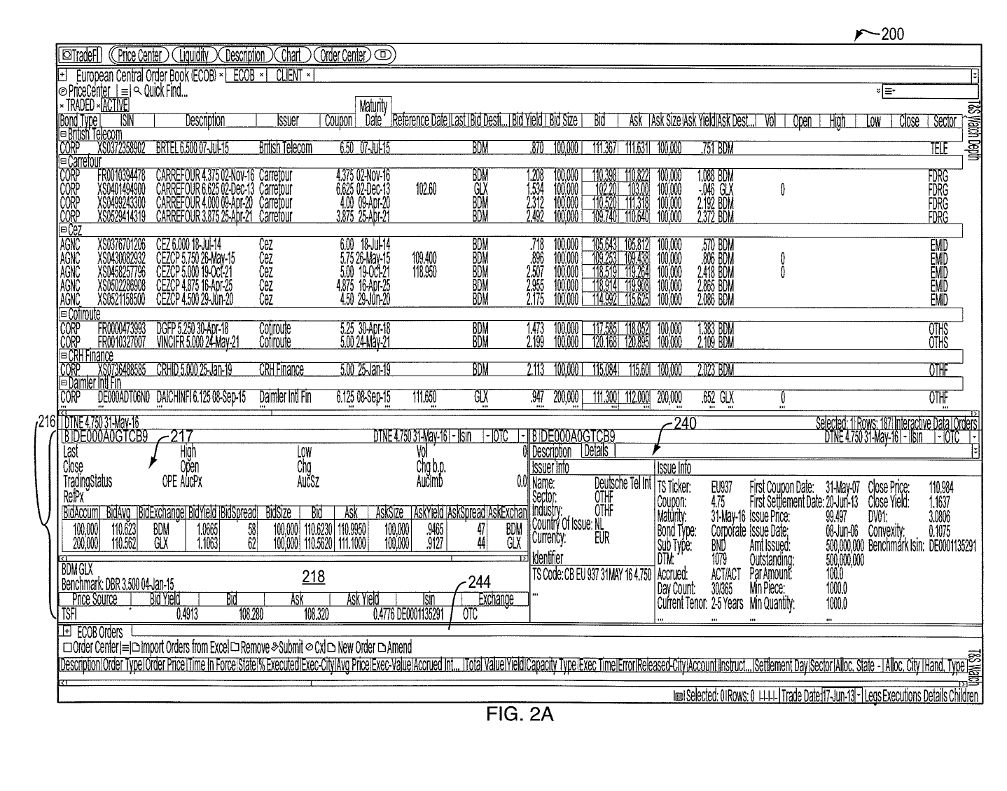

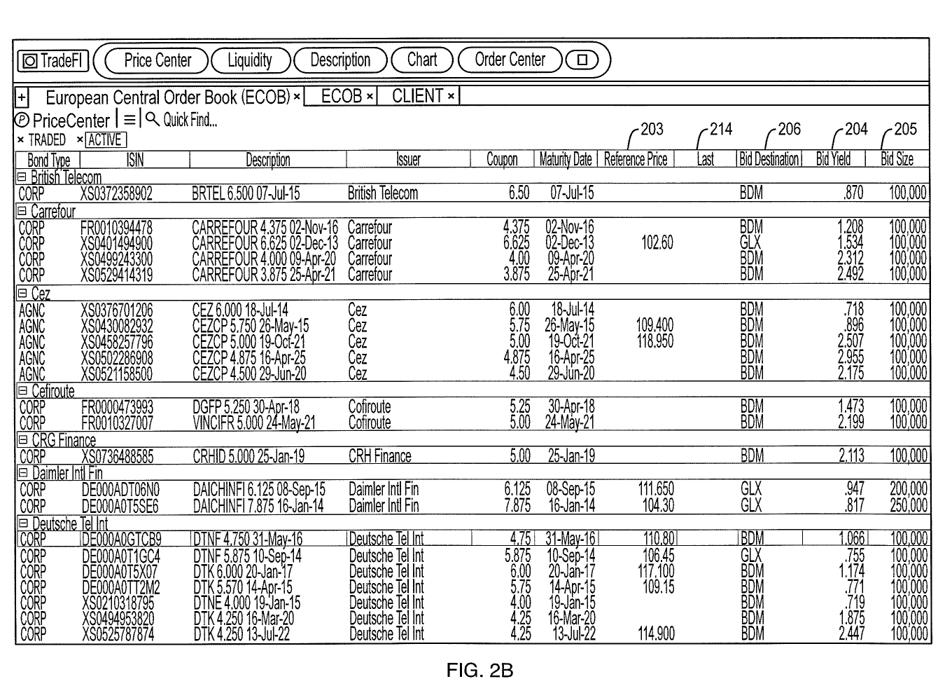

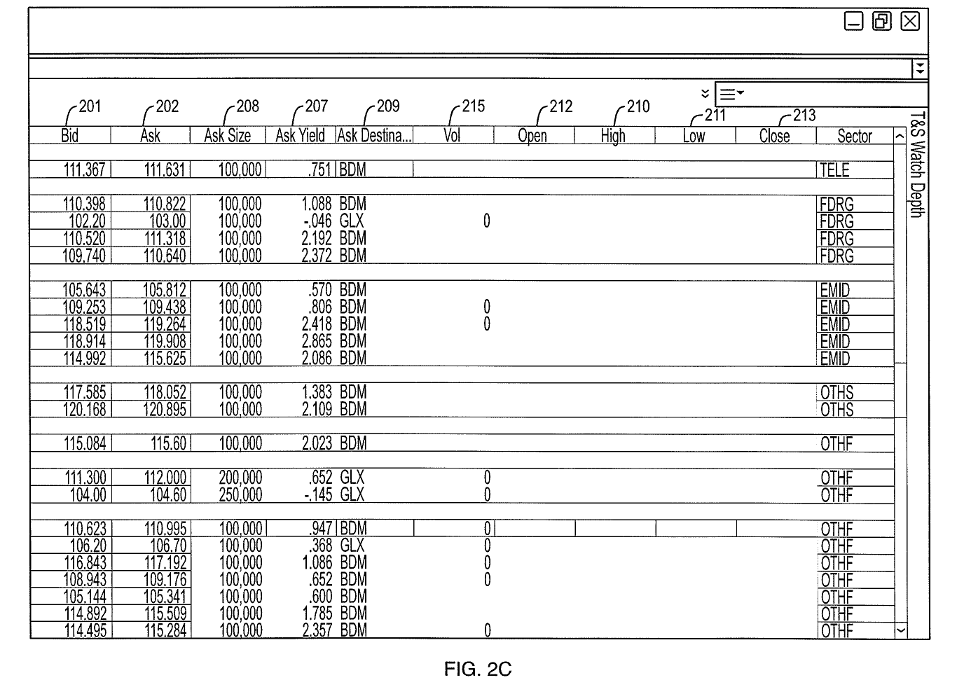

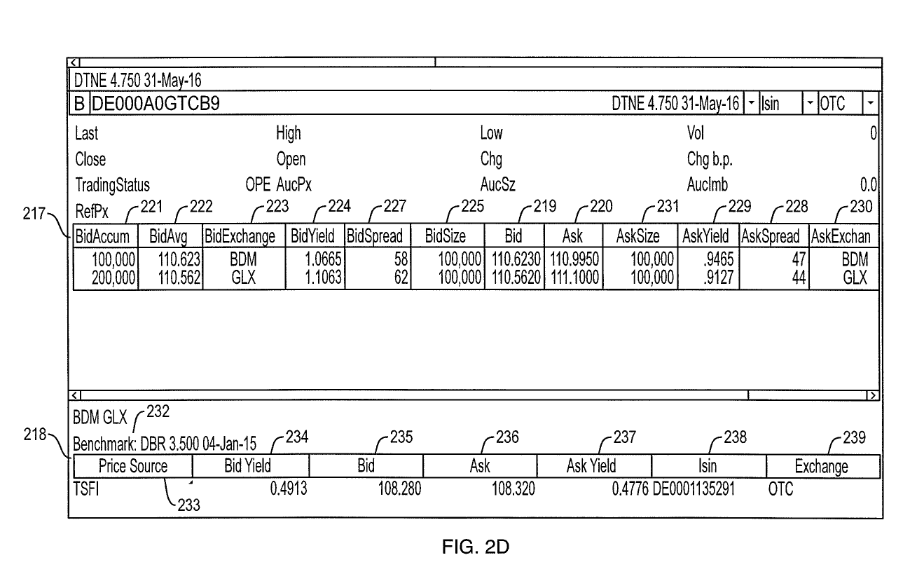

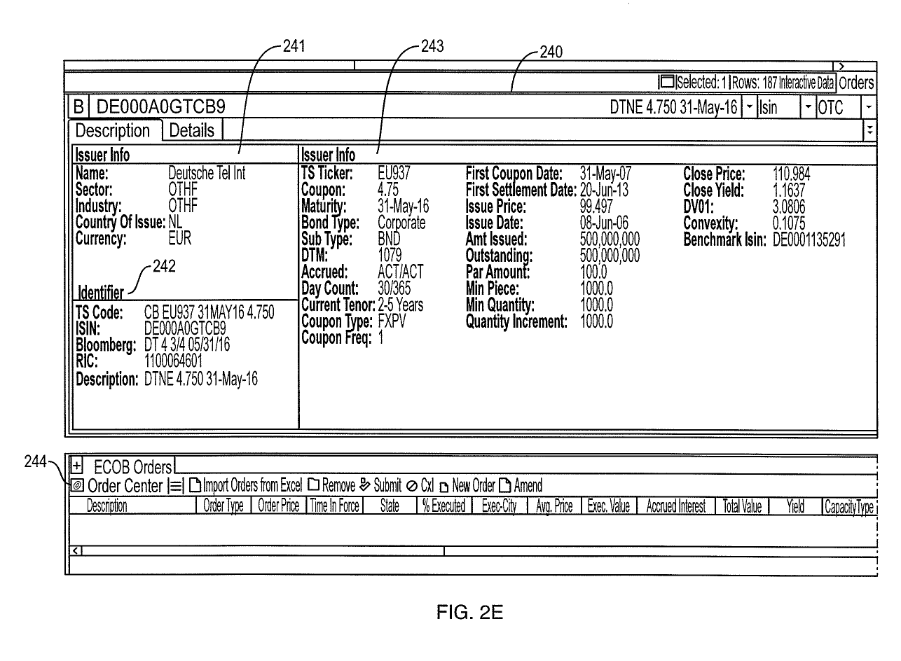

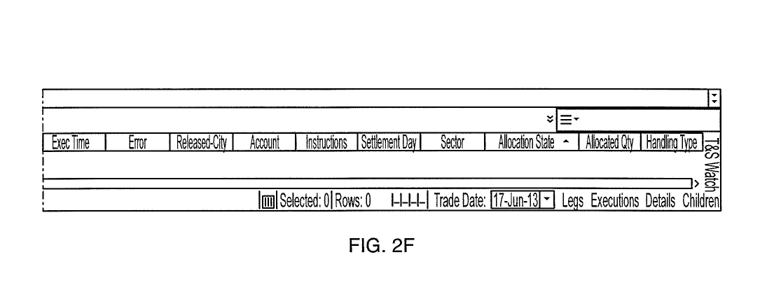

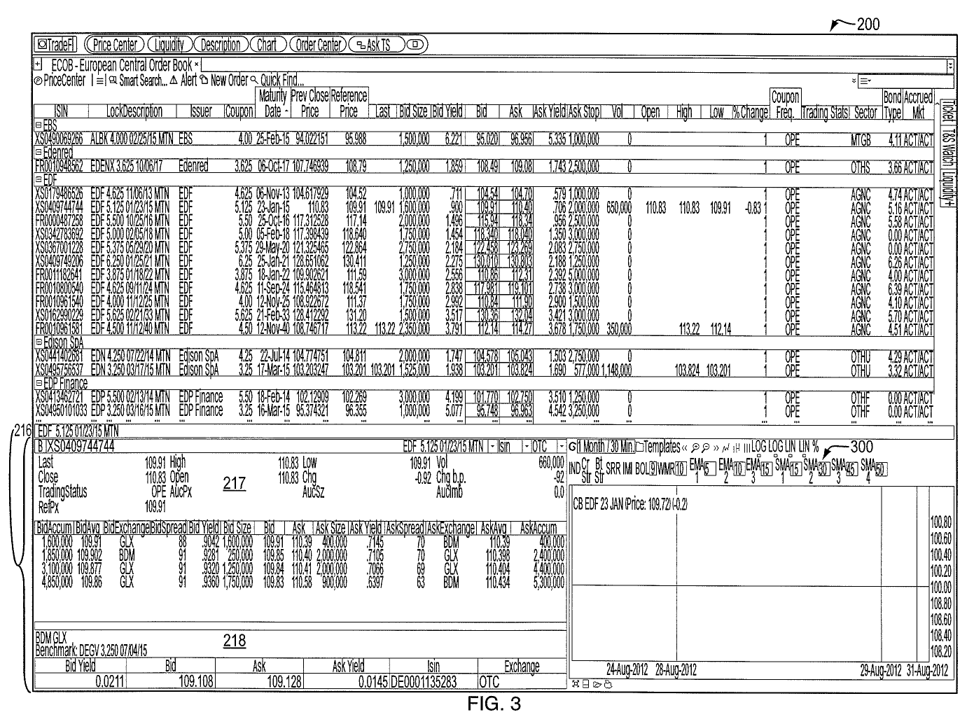

For example, decision processing module 32 (i.e., software executed on a computer processor) determines whether the key/value data element (from data repository 20) represents information that is displayed in its received state. If so, the data is processed by publish processing module 33 (i.e., software executed on a computer processor) and made available for display on a display screen interface 34 (e.g., Price Center View Pane, Liquidity View Pane, Description View Pane or Chart View Pane, described below with reference to FIGS. 2 and 3).

If decision processing module 32 determines that additional processing is required, key/value data elements related to the Bid/Ask prices received from the market venues 15, 16, and 17 undergo a comparative analysis by Best Bid or Offer (“BBO”) and size processing module 35 (i.e., software executed on a computer processor) to determine the best Bid/Ask price for each security. This information is then used to determine how the Bid/Ask prices are displayed on the display screen interface 34 in relation to the Bid/Ask price information previously received from each market venue (e.g., more favorable Bid/Ask prices are posted above less favorable prices previously received).

Certain key/value data elements, such as the Bid/Ask price information received from the market venues, are utilized by the analytical processing module 36 (i.e., software executed on a computer processor), along with other analytical security reference data from repository 37, to produce the DV01 and convexity calculations that are published on the display screen interface 34.

FIGS. 2A-2F and 3A-3E illustrate exemplary user interfaces that may be employed in connection with the methods and systems of the present invention by a user as a component of the trading tools on his desktop computer. These examples relate to the European Central Order Book (ECOB) for the European market venues for fixed income securities. However, the invention is not so limited and can also be used in connection with other market venues for fixed income securities, including those outside Europe (e.g., the United States).

A user interface, including Price Center View Pane 200, is shown and described with reference to FIGS. 2A-2F. FIG. 2A shows the view panes as they would appear in single user interface. FIGS. 2B-2F show the same view panes individually. The Price Center View Pane 200, shown in FIG. 2A in its entirety, as well as FIGS. 2B and 2C in two parts for ease of view, conveys information for all the securities listed on the aggregated ECOB market venues, currently the Galaxy multilateral trading facility and NYSE BondMatch exchange for European fixed income securities. This list of securities is updated on a real-time basis with the most current Bids and Asks prices posted by market participants, using the processes described previously. Securities that do not currently have Bids or Asks prices posted are viewable, but will not have information populated in the fields of Bid column 201 or Ask column 202.

The Price Center View Pane 200 displays a composite price feed across all market venue order books showing the pricing information for each listed security. The Price Center viewing pane contains the following information (shown in FIGS. 2B and 2C), in one embodiment:

Reference Price 203: Indicative price of the security calculated by the market venue;

Bid: Best Bid information across all market venues;

Bid Price (Bid column 201), Bid Yield 204, Bid Size 205, Bid Destination 206 (i.e., market venue name);

Ask: Best Ask information across all market venues;

Ask Price (Ask column 202), Ask Yield 207, Ask Size 208, Ask Destination 209 (market venue name);

High 210: Highest traded price across all market venues;

Low 211: Lowest traded price across all market venues;

Open 212 and Close 213: Volume weighted average across all market venues;

Last Price 214: Last traded price across all market venues; and

Volume 215: Total volume traded across all market venues.

The Liquidity View Pane 216 (shown in FIGS. 2A, and 2D) may be divided into two sections. When a particular security is chosen (“clicked on”) in the Price Center View Pane 200, the individual Bid and Ask postings for all market venues is displayed in the top portion of the Liquidity View Pane 217 and the relevant information for the corresponding Benchmark security is displayed in the bottom portion of the Liquidity View Pane 218.

The following information may be displayed in the top portion of the Liquidity View Pane 217:

The total number of Bid postings and Ask postings across all market venues displayed side-by-side for the security chosen (“click-on”) in the Price Center View Pane 200 in descending order from most favorable price to least favorable price;

BidAccum 221: The cumulative total of bid orders starting at the top in descending order;

BidAvg 222: The cumulative average price of the bid orders starting at the top in descending order;

Bid Exchange 223, Bid Yield 224, Bid Size 225 and Bid 219: The individual order postings for each market venue;

Bid Spread 227: The difference between the Bid yield 224 of this security and the Bid yield of its identified Benchmark security;

AskAccum (not shown): The cumulative total of Ask orders starting at the top in descending order;

AskAvg (not shown): The cumulative average price of the Bid orders starting at the top in descending order;

Ask Exchange 230, Ask Yield 229, Ask Size 231 and Ask 220: These represent the individual order postings for each market venue; and

Ask Spread 228: Represents the difference between the Ask yield of this security and the Ask yield of its identified Benchmark security.

The following information is displayed in the bottom portion of the Liquidity View Pane 218:

Name 232 of security that serves as the Benchmark security for the fixed income security chosen (“clicked-on”) in the Price Center View Pane 200;

Price Source 233: Identifies the source of pricing for the Benchmark security;

BidYield 234, Bid 235, Ask 236, Ask Yield 237: The current information for this security obtained from the identified pricing source;

ISIN 238: A security code identifier; and

Exchange 239: The market venue from which the pricing information is obtained;

The Description View Pane 240 (shown in FIGS. 2A and 2E) reflects information related to the specific security chosen (“clicked-on”) in the Price Center View Pane 200. The Description View Pane 240 has two tabs (“Description” and “Details”). The Description Tab is divided into three sections and contains the following information:

Issuer Info 241: Name, Sector, Industry, Country of Issue and Currency of this security;

Identifier 242: Industry specific security identifier codes assigned by various organizations (TS Code, ISIN, Bloomberg, Reuters, etc.); and

Issue Info 243: Key information related to the specific issue of securities chosen—Coupon, Maturity, Bond Type, Sub-type, Day-to-Maturity (DTM), Interest Accrual method, Interest calculation day count, Current Tenor classification, Coupon Type, Coupon Frequency, First Coupon Date, First Settlement Date, Issue Price, Issue Date, Amount Issued, Amount Outstanding, Par Amount, Minimum Piece/Minimum Quantity (minimum trading size), Quantity Increment (minimum transaction size increments above the minimum Piece/Quantity), Close Price, Close Yield, DV01 (dollar value of one basis point change in the yield of the security), Convexity (percentage change in the duration (price sensitivity) of this security resulting from a change in interest rates), Benchmark ISIN (industry identifier for the “risk-free” fixed income security used as a benchmark reference for this corporate security (typically a sovereign issuance)).

The Details Tab contains a listing of industry specific security identifier codes, issue information, industry ratings, market and regulatory information.

When a specific security is chosen (“clicked-on”) in the Price Center View Pane 200, the Order Center View Pane 244 (shown in FIG. 2A in its entirety, as well as FIGS. 2D and 2E) displays the order-level data elements for both completed and working orders.

The Order Center View Pane 244 may display the following set of order elements:

Creation, Owner, Executing Broker, Side, Order Quantity, Security Identifier Code (e.g., ISIN), Description, Order Type, Order Price, Time in Force, State (order status), % Executed, Execution Quantity, Average Execution Price, Notional Execution Value, Accrued Interest, Total Transaction Value, Yield, Capacity (principal, Agent), Execution Time, Error, Released Quantity (for amended orders), Account, Instructions, Settlement Day, Sector, Allocation State, Allocated Quantity, Order Handling Instructions (market order, limit order, etc.).

Referring now to FIG. 3, Chart View Pane 300 is a preset configuration that displays data elements on an intraday or historic basis (e.g., by week, month, quarter) utilizing the last traded price for the security chosen (“clicked-on”) in the Price Center View Pane 200.

The Time & Sales View Pane (not shown) facilitates the real-time aggregation of executed transactional information (“Time & Sales”) across all market venues for the security chosen (“clicked-on”) in the Price Center View Pane 200. The Time & Sales View Pane may include the following information:

Product: Name of security traded;

Time of trade;

Price: The transaction price;

Size: Denotes number of securities traded; and

Venue: Denotes market venue where security traded.

Double clicking on a specific bond listed on the Price Center View Pane 200 may open a trading ticket viewable in an Order Ticket Entry Pane (not shown). This ticket allows the user to enter a quantity, price or yield, order type (market, limit, all or none), order duration (on-open, on-close, good till day and good-till-canceled) and submit a completed order for execution to the market venue(s) displaying offerings that meet the user's order criteria.

The data elements displayed in the Order Ticket Entry Pane may include:

Bid, Bid Size, Bid Venue as displayed by each market;

Ask, Ask Size, Ask Venue as displayed by each market;

Ask Working and Bid Working: the live working quantity at each level; and

Bought and Sold: the executed quantity at each level.

There may be additional components on the ticket whereby the user can specify which market venues can be authorized before sending the order to an intermediary for execution.

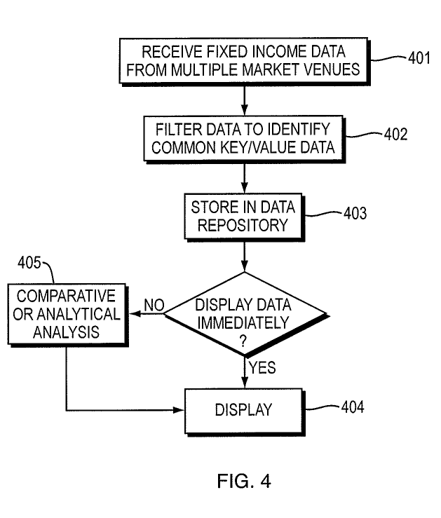

With reference to FIG. 4, a flow chart is provided, illustrating a preferred embodiment of a method of the present invention. In step 401, one or more sets of data describing one or more fixed income securities are received from each of multiple market venues by a computer processor. In step 402, data contained within each of the sets of data is filtered to identify key/value data common to each set of data, the key/value data comprising, for each of the fixed income securities, securities industry identifier codes; a Bid price; an Ask price; a Bid size; an Ask size; a Bid yield; an Ask yield; a last trade price and quantity for executed trades; an execution time stamp; and a reference price. In step 403, the filtered data is stored in a data repository. In some embodiments, in step 404, the filtered data is displayed on a user interface, e.g., immediately upon receipt. In certain other embodiments, a comparative analysis or analytical analysis is performed on the filtered data, in step 405, and a result of the comparative analysis is displayed on the user interface in step 404.

Exemplary hardware and software employed by the systems discussed herein are now generally described. Database server(s) may include a database services management application that manages storage and retrieval of data from the database(s). The databases may be relational databases; however, other data organizational structure may be used without departing from the scope of the present invention. One or more application server(s) are in communication with the database server. The application server communicates requests for data to the database server. The database server retrieves the requested data. The application server may also send data to the database server for storage in the database(s). The application server comprises one or more processors, computer readable storage media that store programs (computer readable instructions) for execution by the processor(s), and an interface between the processor(s) and computer readable storage media. The application server may store the computer programs referred to herein.

To the extent data and information is communicated over the Internet, one or more Internet servers may be employed. The Internet server also comprises one or more processors, computer readable storage media that store programs (computer readable instructions) for execution by the processor(s), and an interface between the processor(s) and computer readable storage media. The Internet server is employed to deliver content that can be accessed through the communications network, e.g., by an end user. When data is requested through an application, such as an Internet browser, the Internet server receives and processes the request. The Internet server sends the data or application requested along with user interface instructions for displaying a user interface.

The computers referenced herein are specially programmed, in accordance with the described algorithms, to perform the functionality described herein.

The non-transitory computer readable storage media that store the programs (i.e., software modules comprising computer readable instructions) may include volatile and non-volatile, removable and non-removable media implemented in any method or technology for storage of information such as computer-readable instructions, data structures, program modules, or other data. Computer readable storage media may include, but is not limited to, RAM, ROM, Erasable Programmable ROM (EPROM), Electrically Erasable Programmable ROM (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computer system and processed.

It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and features of the disclosed embodiments may be combined. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the method does not rely on the particular order of steps set forth herein, the particular order of the steps should not be construed as limitation on the claims. The claims directed to the method of the present invention should not be limited to the performance of their steps in the order written, and one skilled in the art can readily appreciate that the steps may be varied and still remain within the spirit and scope of the present invention.

What is claimed is:

1. A computer implemented method comprising:
receiving, by a computer processor, at least one set of data describing one or more fixed income securities from each of multiple market venues;
filtering, by the computer processor, data contained within each of the sets of data to identify key/value data common to each set of data, the key/value data comprising, for each of the fixed income securities, securities industry identifier codes; a bid price; an ask price; a bid size; an ask size; a bid yield; an ask yield; a last trade price and quantity for executed trades; an execution time stamp; and a reference price; and
storing the filtered data in a data repository.

2. The computer implemented method of claim 1, further comprising:
displaying the filtered data on a user interface.

3. The computer implemented method of claim 1, further comprising:
performing comparative analysis on the filtered data; and
displaying a result of the comparative analysis on a user interface.

4. The computer implemented method of claim 1, further comprising:
performing analytical analysis on the filtered data; and
displaying a result of the analytical analysis on a user interface.

5. A system comprising:
one or more memory units each operable to store at least one program; and
at least one processor communicatively coupled to the one or more memory units, in which the at least one program, when executed by the at least one processor, causes the at least one processor to perform the steps of:
receiving at least one set of data describing one or more fixed income securities from each of multiple market venues;
filtering data contained within each of the sets of data to identify key/value data common to each set of data, the key/value data comprising, for each of the fixed income securities, securities industry identifier codes; a bid price; an ask price; a bid size; an ask size; a bid yield; an ask yield; a last trade price and quantity for executed trades; an execution time stamp; and a reference price; and
storing the filtered data in a data repository.

6. The system of claim 5, the processor further being caused to perform the steps of:
displaying the filtered data on a user interface.

7. The system of claim 5, the processor further being caused to perform the steps of:
performing comparative analysis on the filtered data; and
displaying a result of the comparative analysis on a user interface.

8. The system of claim 5, the processor further being caused to perform the steps of:
performing analytical analysis on the filtered data; and
displaying a result of the analytical analysis on a user interface.

9. A non-transitory computer readable medium storing instructions which, when executed by a computer processor, cause the computer processor to perform a method comprising:
receiving one or more sets of data describing one or more fixed income securities from each of multiple market venues;
filtering data contained within each of the sets of data to identify key/value data common to each set of data, the key/value data comprising, for each of the fixed income securities, securities industry identifier codes; a bid price; an ask price; a bid size; an ask size; a bid yield; an ask yield; a last trade price and quantity for executed trades; an execution time stamp; and a reference price; and
storing the filtered data in a data repository.

10. The non-transitory computer readable medium of claim 9, the method further comprising:
displaying the filtered data on a user interface.

11. The non-transitory computer readable medium of claim 9, the method further comprising:
performing comparative analysis on the filtered data; and
displaying a result of the comparative analysis on a user interface.

12. The non-transitory computer readable medium of claim 9, the method further comprising:
performing analytical analysis on the filtered data; and
displaying a result of the analytical analysis on a user interface.
